(19) United States
(12) Patent Application Publication
(10) Pub. No.: US 2007/0094051 A1
(43) Pub. Date: Apr. 26, 2007

(54) Method for conducting business at a medical practice

(76) Inventor: Catherine Gaye Banks, Sydney (AU)

Correspondence Address: KENNETH M. FAGIN, 136 SUMMER WALK DRIVE, GAITHERSBURG, MD, 20878, US

(21) Appl. No.: 11/253,637

(22) Filed: Oct. 20, 2005

(51) Int. Cl. G06F 17/30; G07G 1/14; G06F 19/00; G06F 7/00; G06F 17/00

(52) U.S. Cl. 705/3; 707/3; 705/14; 715/507

(57) ABSTRACT

The invention concerns a method for conducting business at a medical practice. The method includes acquiring a customizable medical database containing information about medical conditions, and personalizing the database with details of the medical practice. The method further includes providing consultations at the medical practice, including identification of a patient's condition. The method further includes selecting subject matter relevant to the patient's condition in a database query and printing an information sheet from the database in response to the query. The information sheet is automatically personalized to identify the medical practice and to contain information about the patient's condition. The invention further concerns a customizable database containing information about medical conditions. The database is operable to personalize it with details of a medical practice and to select subject matter relevant to a patient's condition in a database query so that an information sheet can be selectively printed from the database in response to the query. The information sheet is automatically personalizable to identify the medical practice and information about the patient's condition.

### TECHNICAL FIELD

This invention concerns a method for conducting business at a medical practice. In particular it concerns a method for customizing and using a database. In a further aspect the invention concerns a customizable medical database.

### DISCLOSURE OF THE INVENTION

In a first aspect the invention is a method for conducting business at a medical practice, the method comprising:

acquiring a customizable medical database containing information about medical conditions;

personalizing the database with details of the medical practice;

providing consultations at the medical practice, including identification of a patient's condition;

selecting subject matter relevant to the patient condition in a database query; and

printing an information sheet from the database in response to the query; wherein the information sheet is automatically personalized to identify the medical practice and to contain information about the patient's condition.

It should be appreciated that the term medical practice refers to the provision of services for one or more of, but not limited to, medicine, dentistry, psychiatry and allied health services such as physiotherapy and osteopathy. Medicine may include veterinary medicine.

The information in the database may be multilingual.

The method may further comprise selecting the preferred language of the patient in the database query.

The information sheet may be automatically personalized to contain information about the patient's condition in the selected language.

The information sheet may also be customizable with patient details including, but not limited to, the patient's name, the patient's contact address and/or telephone number, and healthcare information should the patient belong to a medical fund.

The information sheet may also contain a link to a web-site containing further information about the patient's condition.

The information sheet or web-site, or both may contain an advertisements for a product relevant to the patient's condition.

Embodiments of the invention may offer one or more of the following benefits to a medical practice:

a second level of service where patients leave with a tangible information sheet that supports and reinforces the consultation;

a second level of service that does not take up valuable consultation time;

efficient promotion of health education;

advertising in a positive, yet subtle manner;

enabling selection of the patient's preferred language and thereby removing the language barrier when English is not the patient's first language.

At least an embodiment of the invention further has the advantage of positively reinforcing the medical practice, to not only patients, family and friends, but also the general community in which the medical practice is located.

In an example where the medical practice comprises or includes the provision of services for veterinary medicine the patient is obviously an animal. In this example the method may comprise selecting the preferred language of the patient's owner in the database query so that the information sheet may be automatically personalized to contain information about the patient's condition in the selected language.

Although the first aspect of the invention refers to a method for conducting business at a medical practice, those skilled in the art will appreciated that the method for conducting business may be applied to practices other than medical practices, for example a law practice, an accountancy practice, a superannuation company practices and insurance company practices.

For example, the invention may concern a method for conducting business at a legal practice, the method comprising:

acquiring a customizable legal database containing information about legal conditions;

personalizing the database with details of the legal practice;

providing consultations at the legal practice, including identification of a client's situation;

selecting subject matter relevant to the client's situation in a database query; and

printing an information sheet from the database in response to the query; wherein the information sheet is automatically personalized to identify the legal practice and to contain information about the client's situation.

In a second aspect, the invention is a customizable database for holding information about conditions, such as but not limited to, medical conditions, wherein the database is operable to personalize it with details of a medical practice, and to select subject matter relevant to a patient's condition in a database query; so that an information sheet can be selectively printed from the database in response to the query; and wherein the information sheet is automatically personalizable to identify the practice and information about the patient's condition.

The information contained in the customizable database may be multilingual.

The subject matter may be selected in accordance with a selected preferred language.

The information sheet may be automatically personalized to contain information about the patient's condition in the selected language.

The database may contain information, or have access to information, which relate to advertisements for products relevant to a range of medical conditions.

The database may contain information, or have access to information, which relate to web sites which relate to a range of medical conditions, and/or to web sites which relate to advertisements for products relevant to a range of medical conditions.

As for the first aspect of the invention it should be appreciated that the term medical practice refers to the provision of services for one or more of medicine, dentistry, psychiatry, veterinary etc.

### BRIEF DESCRIPTION OF THE DRAWINGS

An example of the invention will now be described with reference to the accompanying drawings, in which:

FIG. 1 is an example of the layout of an information sheet about Cold Sores;

FIG. 2 is an example of an information sheet about Cold Sores;

FIG. 3 is an example of an information sheet about Hypertension;

FIG. 4 is an example of an information sheet about Hypothyroidism;

FIG. 5 is an example of an information sheet about Rheumatoid Arthritis;

FIG. 6 is an example of an information sheet about Angina; and

FIG. 7 is a flow chart of the flow of business at a medical practice.

### BEST MODES OF THE INVENTION

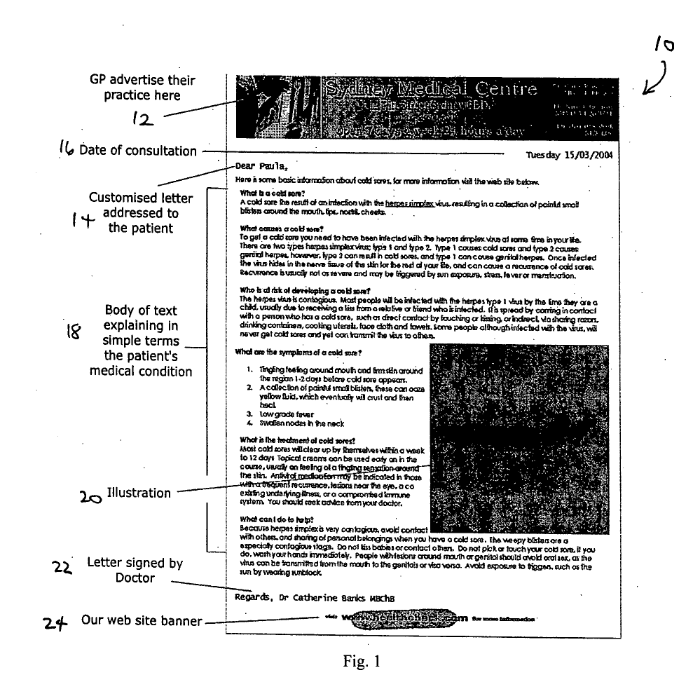

A set of A4 medical information sheets about various medical conditions, and in several different languages, is prepared and stored in software. FIG. 1 explains the layout of the sheet. At the top of sheet 10, there is a personalized masthead 12 of the Medical Practice. Next the name of the patient 14 and date of consultation 16 is printed on the sheet. The body of text 18 explains the patient's complaint in simple terms with an illustration 20. The sheet is signed 22 by the consulting doctor and ends with a web address 24 where further information is available.

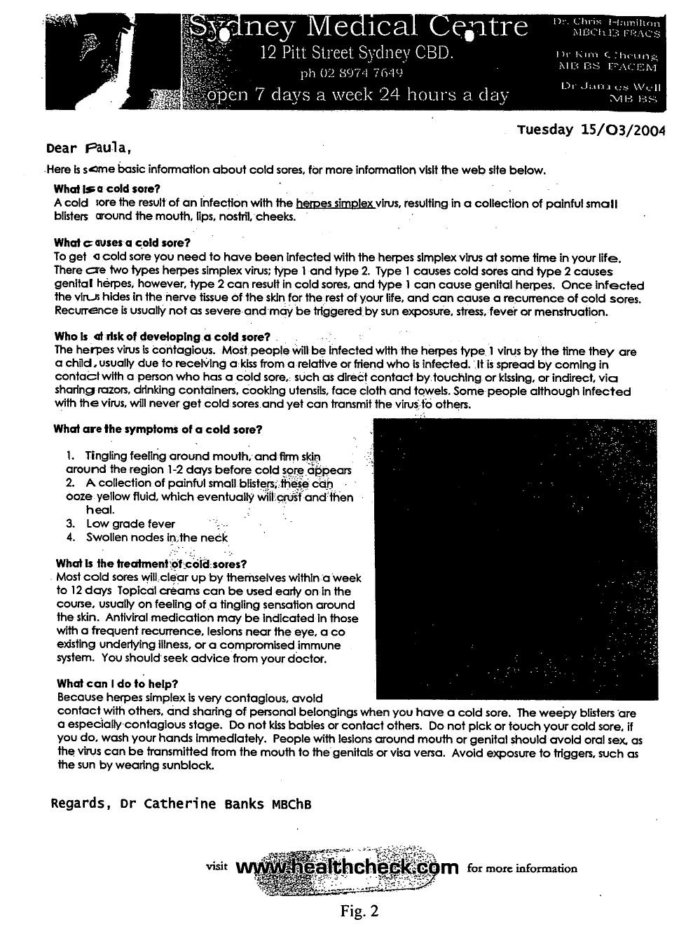

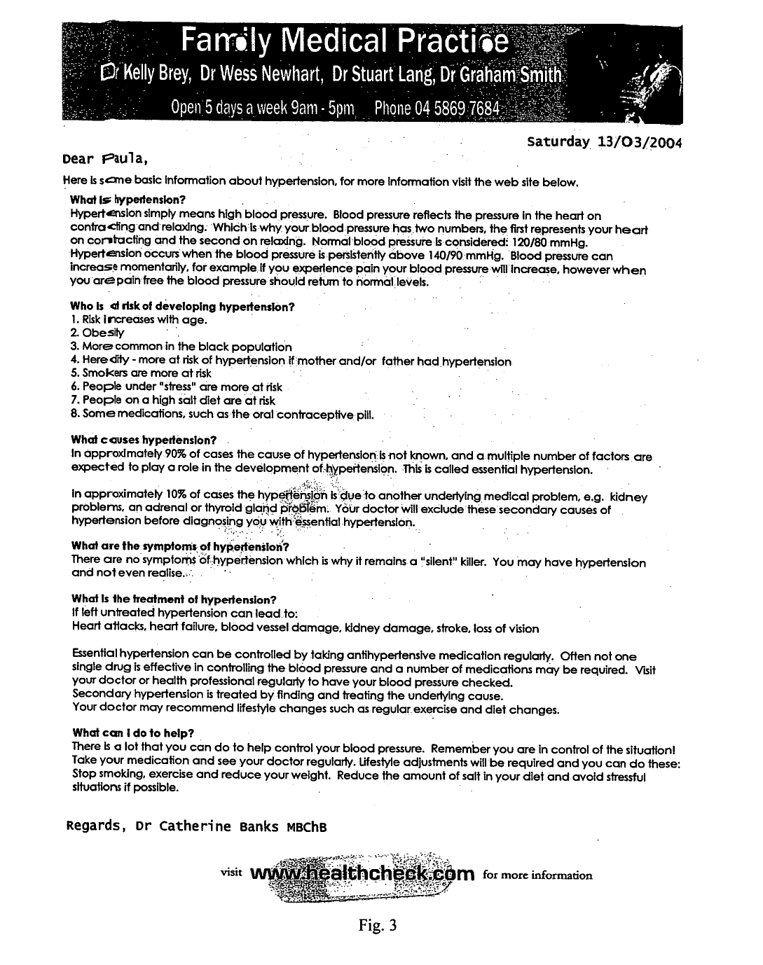

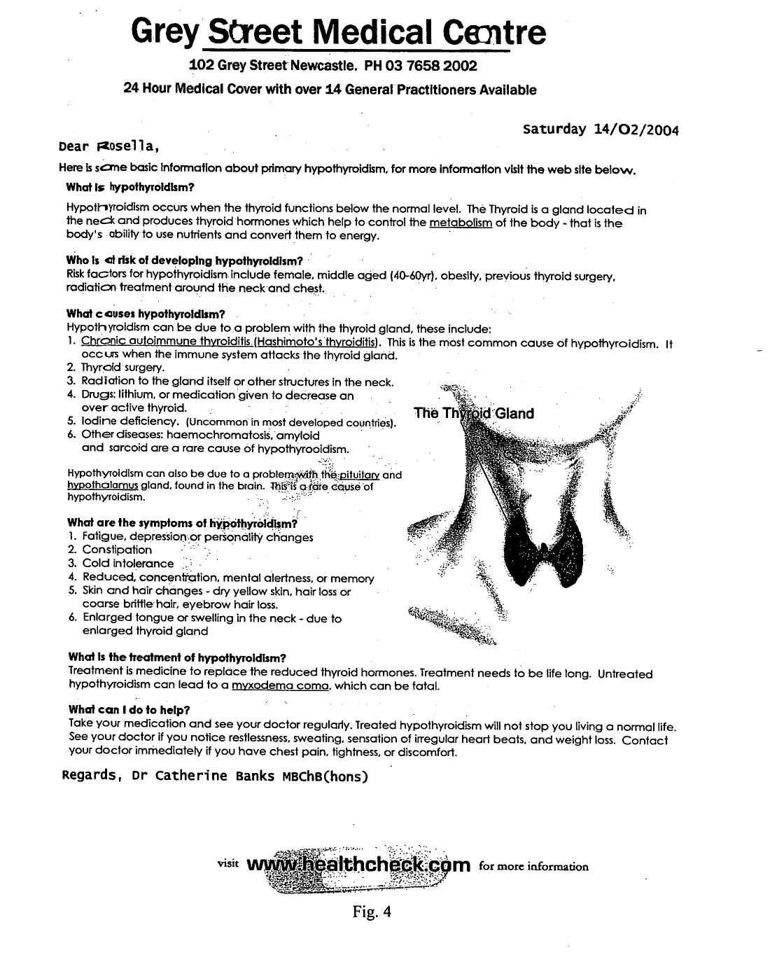

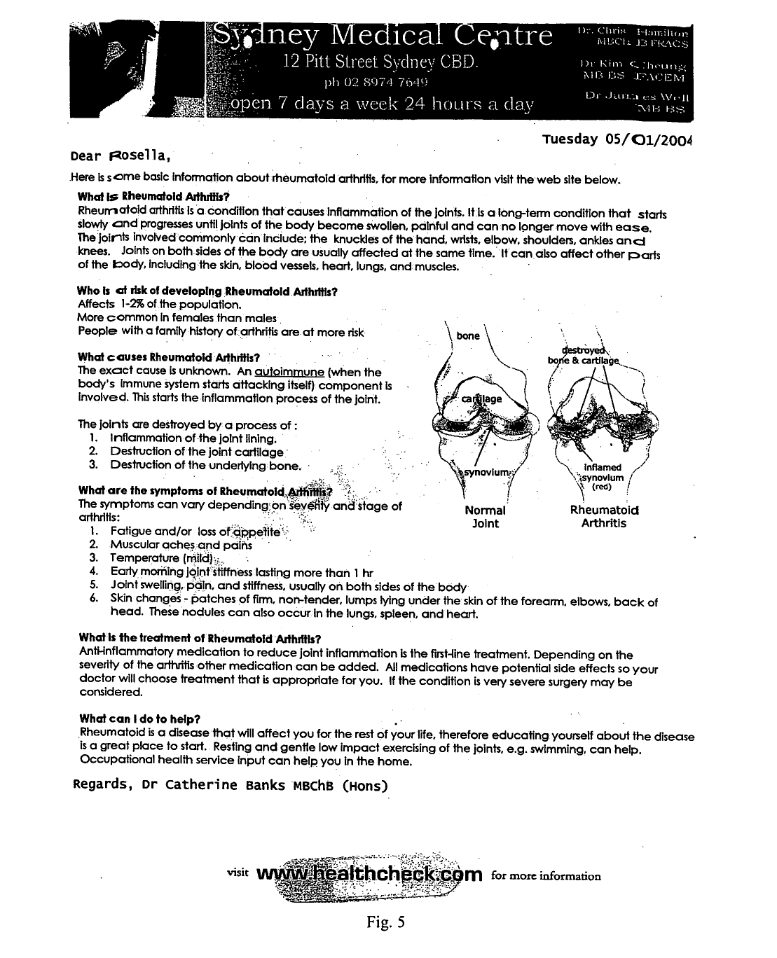

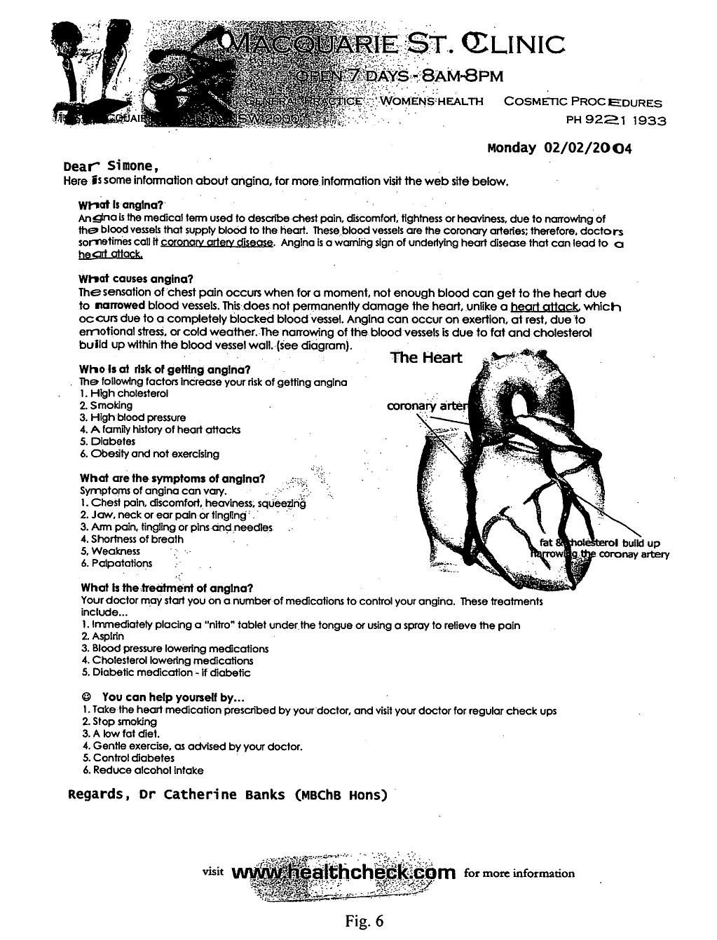

FIGS. 2 to 6 are examples of sample information sheets for a range of different complaints.

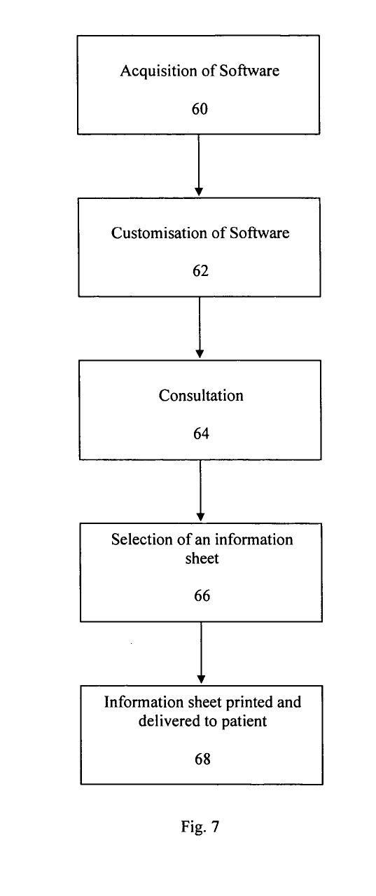

The invention will now be described with reference to FIG. 7. Software may be acquired 60 by a medical practice, for instance by buying a CD ROM or by downloading over the Internet. The software is customized 62 to receive information about each medical practice where it is to be used.

When a patient visits the medical practice with a medical complaint they will consult a doctor 64. Afterwards the doctor instructs a receptionist to print out 66 a medical information sheet relevant to the complaint in the patients language of preference. The information sheet is printed and given to the patient before they leave 68.

The information sheet has a web address at the footer, providing advertising of an Internet site at which patients and families can access more health information about their medical conditions. Here, patients can activate a search for the medical topic. Alternatively, they may view an index or view it via organ categories, for example, cardiovascular or respiratory. A spell checker is available since medical terms can be very difficult to spell. The checker responds to unknown queries by asking “did you mean [best guess]”. This along with the index will help eliminate language difficulties in using the site.

The site also provides links to other medical sites that adhere to the World Health Organisation's Health on the Internet code. Information accessible will be at a local, regional, national and international level. For example, a support group for Alzheimer's disease in a particular locality can be found. Online support groups can also be accessed, allowing the patient round the clock access to support, via chat rooms around the world. In another example, there is are links to other health service providers in the user's suburb or town, including Hospitals, General Practitioners, physiotherapists, dentists, optometrists, occupational therapists, nursing homes, and hostels. Information such as maps, addresses, telephone numbers, and opening hours will be available.

Relevant advertising will be presented on appropriate pages. For instance, pharmaceutical, medical, herbal and vitamin, and insurance companies, are able to advertise on these sites. The advertising will be “product specific”, for example, DVT stocking companies might advertise on the thrombosis internet page. This is in contrast to the information sheets which will advertise only the Medical Practice.

A disclaimer will be displayed at the bottom of each information sheet and on the web site. It will state that this information is to support, not replace recommendations of doctors or health professionals.

As previously stated, the term medical practice refers to the provision of services for one or more of medicine, dentistry, psychiatry, veterinary etc. In an example where the medical practice comprises or includes the provision of services for veterinary medicine the patient is obviously an animal. In such an example the method comprises selecting the preferred language of the patient's owner in the database query so that the information sheet is able to be automatically personalized to contain information about the patient's (animal's) condition in the selected language of the animal's owner.

Although the method for conducting business has been described in relation to a medical practice, those skilled in the art will appreciated that the method for conducting business may be applied to other practices, for example, but not limited, to law practices, superannuation company practices and insurance company practices. Accordingly, the method described herein should not be construed in a limiting manner.

Although the customizable database has been described as containing information about medical conditions, those skilled in the art will appreciated that the customizable database may contain information about conditions related to legal matters, superannuation matters, insurance matters, and the like. Accordingly, the database described herein should not be construed in a limiting manner.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for conducting business at a medical practice, the method comprising:
acquiring a customizable medical database containing information about medical conditions;
personalizing the database with details of the medical practice;
providing consultations at the medical practice, including identification of a patient's condition;
selecting subject matter relevant to the patient's condition in a database query; and
printing an information sheet from the database in response to the query; wherein the information sheet is automatically personalized to identify the medical practice and to contain information about the patient's condition.

2. The method according to claim 1, wherein information in the database is multilingual.

3. The method according to claim 2, further comprising selecting a preferred language of the patient in the database query.

4. The method according to claim 3, wherein the information sheet is automatically personalized to contain information about the condition in the selected language.

5. The method according to claim 1, wherein the information sheet is customizable with one or more patient details.

6. The method according to claim 1, wherein the information sheet further contains a link to a web-site containing further information about the patient's condition.

7. The method according to claim 6, wherein the web-site contains an advertisement for a product which is relevant to the patient's condition.

8. The method according to claim 1, wherein the information sheet contains an advertisement for a product which is relevant to the patient's condition.

9. A customizable database for holding information about medical conditions, wherein the database is operable to personalize it with details of a medical practice, and to select subject matter relevant to a patient's condition in a database query; so that an information sheet is selectively printable from the database in response to the query; and wherein the information sheet is automatically personalizable to identify the practice and information about the patient's condition.

10. The database according to claim 9, wherein information contained in the database is multilingual.

11. The database according to claim 10, wherein the subject matter is selected in accordance with a selected preferred language.

12. The database according to claim 11, wherein the information sheet is automatically personalized to contain information about the patient condition in the selected language.

13. The database according to claim 9, wherein the database further holds information which relate to advertisements for products relevant to a range of medical conditions.

14. The database according to claim 13, wherein the information sheet is automatically personalized to contain an advertisement for a product which is relevant to the patient's condition.

15. The database according to claim 9, wherein the database further holds links to web sites which relate to a range of medical conditions.

16. The database according to claim 15, wherein the information sheet is automatically personalized to contain a link to a web-site containing further information about the patient's condition.

17. The database according to claim 9, wherein the database further holds links to web sites which relate to advertisements for products relevant to a range of medical conditions.

18. The database according to claim 17, wherein the information sheet is automatically personalized to contain a link to a web-site containing an advertisement for a product relating to the patient's condition.
